(19) United States
(12) Patent Application Publication
(10) Pub. No.: US 2014/0282490 A1
(43) Pub. Date: Sep. 18, 2014

(54) INFORMATION PROCESSING SYSTEM, INFORMATION PROCESSING APPARATUS, AND RECORDING MEDIUM STORING INFORMATION PROCESSING PROGRAM

(71) Applicants: Kiyohiko SHINOMIYA, Tokyo (JP); Shigeo NEGORO, Tokyo (JP); Keisuke IWASA, Kanagawa (JP)

(72) Inventors: Kiyohiko SHINOMIYA, Tokyo (JP); Shigeo NEGORO, Tokyo (JP); Keisuke IWASA, Kanagawa (JP)

(73) Assignee: RICOH COMPANY, LTD., Tokyo (JP)

(21) Appl. No.: 14/197,921

(22) Filed: Mar. 5, 2014

(30) Foreign Application Priority Data
Mar. 15, 2013 (JP) 2013-054273

(51) Int. Cl. G06F 9/445

(52) U.S. Cl. CPC G06F 8/61
USPC 717/174

(57) ABSTRACT

An information processing system includes an control unit to accept input, an operating unit to execute information processing based on the input accepted by the control unit, and a registration unit to register functional information that indicates the type of function utilized by an application among a plurality of functions included in the operating unit in accordance with an electronic signature linked to the application included in the control unit.

### CROSS-REFERENCE TO RELATED APPLICATION

This patent application is based on and claims priority pursuant to 35 U.S.C. §119 to Japanese Patent Application No. 2013-054273, filed on Mar. 15, 2013 in the Japan Patent Office, the entire disclosure of which is hereby incorporated by reference herein.

### BACKGROUND

1. Technical Field

The present invention relates to an information processing system, an information processing apparatus, and a recording medium storing an information processing program.

2. Background Art

Conventionally, an information processing system such as a multifunctional peripheral (MFP) is configured as a control unit and an operating unit (main unit). The operating unit performs various processes in response user operations accepted by the control unit, and displays information on the status of the operating unit.

In addition, an information processing system like that described above may be communicably connected to an authentication server, such that, when the information processing system adds functions by installing applications, the information processing system activates (validates) allowance for installing the application.

In such technologies, the expiration date and the number of times the application can be installed (a counter value) are set for applications to be installed or which are already installed in the communicable MFP.

Similarly, a configuration file in which information identifying selected functions is recorded as a condition for launching an application may be acquired from a predetermined recording medium. Subsequently, only the selected functions are utilizable in accordance with the conditions for launching (whereby the functions of the applications can be limited).

### SUMMARY

Example embodiment of the present invention provides an information processing system includes an control unit to accept input, an operating unit to execute information processing based on the input accepted by the control unit, and a registration unit to register functional information that indicates the type of function utilized by an application among a plurality of functions included in the operating unit in accordance with an electronic signature linked to the application included in the control unit.

Example embodiments of the present invention include a non-transitory recording medium storing a program that causes the computer to implement an information processing method executed by an information processing system that includes an control unit to accept input and an operating unit to execute information processing based on the input accepted by the control unit. The method includes the step of registering functional information that indicates the type of function utilized by an application among a plurality of functions included in the operating unit in accordance with an electronic signature linked to the application included in the control unit.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a diagram illustrating an image processing system as a first embodiment of the present invention.

FIG. 2 is a block diagram illustrating a hardware configuration of the image processing system shown in FIG. 1.

FIG. 3 is a diagram illustrating software configurations of a main unit and a control unit shown in FIG. 2 along with functions for network communication.

FIG. 4 is a sequence diagram illustrating the control unit shown in FIG. 2 downloading an application from a server apparatus and installs the application.

FIG. 5 is a flowchart illustrating the control unit shown in FIG. 2 installing the application.

FIG. 6 is a flowchart illustrating control unit shown in FIG. 2 requesting login.

FIG. 7 is a diagram illustrating a home screen displayed by the process shown in FIG. 6.

FIG. 8 is a flowchart illustrating the control unit shown in FIG. 2 updating the application.

FIG. 9 is a diagram illustrating the control unit shown in FIG. 2 downloading an application from a download server and installs the application as a second embodiment of the present invention.

FIG. 10 is a flowchart illustrating the control unit installing the application as a second embodiment of the present invention.

FIG. 11 is a sequence diagram illustrating a process that the control unit requests the server apparatus to authorize to use the application, receives an authorization result, and installs the application as a second embodiment of the present invention.

FIG. 12 is a sequence diagram illustrating a process that the control unit requests the server apparatus to sign the application, receives a signature result, and installs the application as a third embodiment of the present invention.

FIG. 13 is a sequence diagram illustrating a process that the control unit requests the server apparatus to sign the application, receives a signature result, and installs the application as a fourth embodiment of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In the information processing systems described in JP-2011-002978-A and JP-2009-140347-A, the function that limits use of the functions of the application is implemented in the application itself. Consequently, it is impossible to limit use of the application if the application does not have that the function.

### First Embodiment

In the following embodiment, an information processing system is provided that includes an control unit that accepts input, such as inputting a command and an operating unit that executes information processing based on the input, such as the command accepted by the control unit. Each of the control unit and the operating unit has its own operating system (OS). In case of adding or updating a function implemented in the information processing system, the control unit downloads data for adding or updating a function that the information processing system implements.

In this configuration, in the information processing system, it is easily possible to limit utilizing application regardless of functions of the application itself.

FIG. 1 is a diagram illustrating an image processing system as a first embodiment of an information processing apparatus of the present invention.

An image processing system 1 is a MFP that includes communication functions as well as functions such as printing, scanning, and facsimile. A user can operate the image processing system 1 directly and instruct the image processing system to process these functions. Otherwise, the image processing system 1 can execute the functions in response to a command received from an external apparatus such as a client personal computer (PC).

The image processing system 1 can communicate with a server apparatus 2 that transfers data such as application programs to add functions via a network 3.

FIG. 2 is a block diagram illustrating a hardware configuration of the image processing system 1 shown in FIG. 1. As shown in FIG. 2, the image processing system 1 includes an control unit 20 that accepts inputting a command by a user and a main unit 10 as an operating unit that works based on the command accepted by the control unit 20. In the image processing system 1, the control unit 20 and the main unit 10 can communicate with each other via a communication channel 30 for example. In this embodiment, a mobile device equipped with Android Operating System (OS) is used as the control unit 20. It is possible to supply power to the control unit 20 from the main unit 10, or the operational part 20 includes an internal battery (not shown in figures) and can operate independently. In this embodiment, a power wire to supply power from the main unit 10 to the control unit 20 is in common with the communication channel 30.

The main unit 10 can perform an operation in response to not only a command accepted by the control unit 20 but also a command received from the external apparatus as described above. In the present embodiment, the communication channel 30 is compliant with Universal Serial Bus (USB) specification, for example, although the communications channel 30 can be compliant with any wired or wireless specification. In addition, the communications channel 30 can be not only one-to-one but also a network. Other than USB, e.g., serial, wired local area network (LAN), wireless LAN, Bluetooth, and Infrared Data Association (IrDA) can be used for the communication channel 30.

The main unit 10 includes a CPU 11, a ROM 12, a RAM 13, a hard disk drive (HDD) 14, a communications interface (I/F) 15, a connection I/F 16, and an engine unit 17, all connected to a system bus 18. The main unit 10 as a whole is controlled by the CPU 11 executing a program stored in the ROM 12 or the HDD 14 using the RAM 13 as a work area. In addition, various functions described later are implemented by the CPU 11 executing a program stored in the ROM 12 or the HDD 14 using the RAM 13 as a work area.

The HDD 14 is a nonvolatile storage medium (storage unit) and stores various data including various programs executed by the CPU 11.

The communications I/F 15 is an interface to communicate with an external apparatus via the network 3.

The connection I/F 16 is an interface to communicate with the control unit 20 via the communication channel 30. In this embodiment, an interface compliant with USB specification is used for the connection I/F 16. However, any specification whether wired or wireless can be adopted as the communications I/F 15 and the connection I/F 16. One I/F can double as the communications I/F 15 and the connection I/F 16. Conversely, the main unit 10 can include three or more I/Fs used for communicating.

The engine unit 17 is hardware that executes processes to implement the printing function, scanning function, copying function, and facsimile function except general-purpose information processing and communication. For example, the engine unit 17 includes a scanner (an image scanning unit) that scans a document to create and image thereof, a plotter (an image forming unit) that performs printing on sheet material such as paper, and a communication unit that performs facsimile communication, etc. Furthermore, the engine unit 17 can include specific options such as a finisher that sorts printed sheet material and an Auto Document Feeder (ADF) that feeds documents automatically.

The control unit 20 includes a CPU 21, a ROM 22, a RAM 23, a flash memory 24, a communications I/F 25, a connection I/F 26, and a control panel 27, all connected to a system bus 28. The whole of the control unit 20 is controlled by the CPU 21 by executing a program stored in the ROM 22 or the flash memory 24 using the RAM 23 as a work area. In addition, various functions such as controlling installing applications (described later) are implemented by the CPU 21 by executing a program stored in the ROM 22 or the flash memory 24 using the RAM 23 as a work area.

The flash memory 24 is a nonvolatile storage medium (storage unit) and stores various programs executed by the CPU 21 and various data (described later).

The communications I/F 25 is an interface to communicate with an external apparatus such as the server apparatus 2 via the network 3.

The connection I/F 26 is an interface to communicate with the main unit 10 via the communication channel 30. In this embodiment, an interface compliant with USB specification is used for the connection I/F 26. However, any specification, whether wired or wireless, can be adopted as the communications I/F 25 and the connection I/F 26. One I/F can double as the communications I/F 25 and the connection I/F 26. Conversely, the control unit 20 can include more than three I/Fs used for communicating.

The control panel 27 is an operational display unit that includes an control unit that accepts commands to execute various operations and an operation to configure, etc., and a display part that displays operational status and configuration of the image processing system 1. For example, the control panel 27 can be comprised of a liquid crystal display (LCD) panel on which a touch panel is laminated. Furthermore, in addition to or instead of an LCD panel, an control unit such as hardware keys and a display part such as a lamp can be set up.

A heretofore known computer that includes the CPU, ROM, RAM, and communications I/F etc. can be used as hardware of the server apparatus 2 in FIG. 1.

FIG. 3 is a diagram illustrating software configurations of the main unit 10 and the control unit 20 shown in FIG. 2 along with functions regarding network communication.

As shown in FIG. 3, the main unit 10 includes groups of software that consist of an application layer 101, a service layer 102, and an OS layer 103.

Software in the application layer 101 provides predetermined function by operating the hardware resource. For example, a copier application, a scanner application, a printer application, and a fax application are included in the application layer, and they provide various functions such as copy capability, scan capability, print capability, and fax capability.

Software in the service layer 102 intervenes between the application layer 101 and the OS layer 103, and provides an interface for using the hardware resource included in the main unit 10 to the software in the application layer 101. In particular, the software in the service layer 102 implements functions such as accepting request to operate the hardware resources and arbitrating those requests to operate. Examples of the request to operate accepted by the service layer 102 are scanning by the scanner and printing by the plotter for example.

This interface function is provided not only to the application layer 101 in the main unit 10 but also to the application layer 201 in the control unit 20. That is, an application included in the application layer 201 in the control unit 20 can implement various functions using the hardware resources in the main unit 10 (e.g., the engine unit 17) by accessing the service layer 102 too.

The OS layer 103 includes the operating system and provides basic functions that control the hardware included in the main unit 10. The software in the service layer 102 converts the requests to use the hardware resources sent from the various applications into commands that the OS layer 103 can interpret and pass the commands to the OS layer 103. Subsequently, the software in the OS layer 103 executes the commands and instructs the hardware resources to operate in accordance with the requests from the applications.

The application layer 201, the service layer 202, and the OS layer 203 in the control unit 20 have the similar hierarchical structure as the main unit 10 too. Particular functions provided by the applications in the application layer 201 and types of requests to operate that the service layer 202 can accept are different from the case with the main unit 10. While the applications included in the main unit 20 can provide predetermined functions by operating the hardware resources included in the control unit 20, the applications included in the main unit 20 mainly provide user interface (UI) functions for operating and displaying the functions that the main unit 10 includes.

In the image processing system 1 described above, each of the main unit 10 and the control unit 20 can be equipped with an OS individually, and the main unit 10 and the control unit 20 can work independently. In addition, if the main unit 10 and the control unit 20 can communicate with each other, it is not always necessary that the OS of the main unit 10 is the same as the OS of the control unit 20. For example, while the main unit 10 can use Linux as its OS, the control unit 20 can use Android as its OS.

In the image processing system 1 described above, since the main unit 10 is controlled by the OS different from the OS that controls the control unit 20, communication between the main unit 10 and the control unit 20 is performed not as interprocess communication within an apparatus but communication between different apparatuses.

Examples of the communication between the main unit 10 and the control unit 20 include notifying the main unit 10 of a content of a user's command accepted by the control unit 20 (command communication), and notifying the control unit 20 of information to be displayed on the control unit 20 from the main unit 10.

One key point of this embodiment is an operation performed by the image processing system 1 described below. That is, in accordance with electronic signature that corresponds with application included in the control unit 20, type of function that the application can utilize is configured among functions that the main unit 10 (operating unit) includes. Operations including the operation described above are described below.

First, a basic operation that the control unit 20 downloads an application from the server apparatus 2 and installs the application is described below with reference to FIG. 4.

As shown in FIG. 4, the control unit 20 can communicate with the server apparatus 2 shown in FIG. 1 via the network 3.

In case of accepting selecting application to be downloaded and command to download the application using a browser or appropriate client application etc. by user operation, the control unit 20 requests the server apparatus 2 to download the application.

The server apparatus 2 manages files for installing 210 for various applications and stores those files for installing 210. While only one file for installing 210 is shown in FIG. 4, the server apparatus 2 can store multiple files for installing 210 for each of multiple applications.

Each of the files for installing 210 for applications includes an apk file (Android application package file) 211 that includes the application program and signature data 212 as electronic signature (hereinafter referred to as “signature”) added to the apk file 211. If the file for installing 210 for an application includes the signature data 212, the application is called as “signed application.”

After receiving the request to download from the control unit 20, the server apparatus 2 reads the file for installing 210 for the requested application and transfers it to the control unit 20.

After downloading (receiving) the transferred file for installing 210 in response to the request to download, if the signature data 212 is included in the file for installing 210, the control unit 20 checks the signature data 212 and determine whether or not it is OK to install the application that corresponds with the downloaded file for installing 210.

Here, to describe the determination understandably, first, assuming that the control unit 20 checks a general signature, configuration and operation of the control unit 20 and the server apparatus 2 regarding the checking is described in detail below.
(a) The server apparatus 2 stores a private key preliminarily. The control unit 20 as a device that verifies a signature stores public key that pairs with the private key preliminarily.
(b) After receiving the request to download from the control unit 20, the server apparatus 2 reads the apk file 211 corresponding with the requested application. Subsequently, the server apparatus 2 calculates a hash value by operating a hash function on the apk file 211 and acquires the hash value. The signature can be created by encrypting the acquired hash value with the private key. The server apparatus 2 adds the signature as the signature data 212 to the apk file 211 and transfers them as the file for installing 210 to the control unit 20. Otherwise, the file for installing 210 that includes the signature data 212 can be prepared preliminarily.
(c) After downloading the file for installing 210 transferred in response to the request to download, the control unit 20 checks the signature by using the signature data 212 included in the file for installing 210. That is, regarding the apk file 211 and the signature data 212 included in the file for installing 210, the control unit 20 acquires the hash value by operating the hash function on the apk file 211 and the hash value (calculated by the server apparatus 2) by decoding the signature data 212 with the public key.
(d) After checking the acquired two hash values, the control unit 20 determines that the apk file 211 is not manipulated (correct signature) if the two hash values are identical and the apk file is manipulated (incorrect signature) if the two hash values are not identical.

In this embodiment, since the control unit 20 determines whether or not the downloaded application can be installed and which function included in the main unit 10 the application utilizes, the control unit 20 also determines the type of signature added to the downloaded application. The determination can be performed by validating with which public key the validity of the signature is confirmed in accordance with the signature checking method described above.

Therefore, practically, the server apparatus 2 stores multiple private keys, and the control unit 20 stores multiple public keys that correspond to each of the multiple private keys.

In performing the determination in (d) described above, the control unit 20 acquires the hash values by decoding the signature data 212 included in the file for installing 210 transferred in response to the request to download with multiple public keys that the control unit 20 stores itself sequentially. In this case, the type of signature is determined by the type of public key with which the hash value that corresponds to the hash value calculated from the apk file 211 included in the file for installing 210 is acquired. Consequently, the signature type is determined by the type of secret key used for creating the signature (i.e., the type of corresponding public key).

After determining the type of signature included in the file for installing 210 transferred in response to the request to download, the control unit 20 refers to information stored preliminarily. This information in registered in a signature information table that indicates corresponding relationship among the signature type (each pattern), whether or not the application including the signature is installable, and the function that the main unit 10 includes utilized by the application as shown in TABLE 1.

TABLE 1
Signature information table

| | Installable | Function range |
|---|---|---|
| Signature type | or not | (main unit function) |
| Pattern A | Uninstallable | Application is not |
| | | launchable. |
| Pattern B | Installable | Application is not |
| | | launchable. |
| Pattern C | Installable | Application function (Copier) |
| Pattern D | Installable | Application function |
| | | (Scanner) |
| Pattern E | Installable | Application function (Printer) |
| Pattern F | Installable | Application function (Fax) |
| Pattern G | Installable | Application function (Copier |
| | | and Scanner) |
| Pattern H | Installable | No application is utilized. |
| No signature | Uninstallable | Application is not |
| | | launchable. |

If it is determined that the signature data 212 (the signature added to the application) included in the downloaded file for installing 210 is correct based on the referred information, the control unit 20 determines whether or not the application is installable in accordance with the signature type.

In the cases shown in TABLE 1, if the signature added to the application is one of from Pattern B to Pattern H, the control unit 20 determines that the application is installable. If the signature added to the application is Pattern A, the control unit 20 determines that the application is not installable even if the signature included in the application is correct.

Regarding the type of signature added to the application, a registrar of the application or an administrator of the server apparatus 2 decides the signature type and configures it in the server apparatus 2 when the registrar or the administrator configures that the applications are downloadable on the server apparatus 2.

In addition, if it is determined that the downloaded application is installable, the control unit 20 registers the function that the main unit 10 includes utilized by the application in accordance with the type of signature added to the application. Example cases of the registration are that no function included in the main unit 10 is utilized even upon installation of the application (i.e., Pattern H in TABLE 1) and that only a part of functions is utilized (i.e., from Pattern C to Pattern G in TABLE 1). Other than that, a case that the application is not authorized to launch regardless of user's authority (i.e., Pattern A and B and No signature in TABLE 1) is possible.

That is, in accordance with the type of signature added to the downloaded application, the control unit 20 registers the type of function that the application utilizes (functional range) as function information among functions that the main unit 10 includes. The function information is registered in an application information table, for example, as shown in TABLE 2, and the function utilized by the application among the functions that the main unit 10 includes is registered for each of downloaded application names (other identification information can be used).

TABLE 2
Application information table

| Application name | Function category |
|---|---|
| Scan To Cloud | Scanner |
| Eco Copy | Copier |
| Confidential printing | Printer |
| application | |
| Simple Fax transfer | Fax |
| application | |
| Scan To Me application | Scanner |

Next, an operation that the CPU 21 in the control unit 20 installs the application is described below.

FIG. 5 is a flowchart illustrating the control unit 20 shown in FIG. 2 installing the application.

After receiving the selection of the application to be downloaded and the request to download the application, the CPU 21 in the control unit 20 starts the process shown in FIG. 5. The selection of the application and the request to download the application can be performed by user operation on the control panel 27, or they can be performed automatically in case of satisfying predetermined condition configured preliminarily (e.g., reaching at configured time).

In the process shown in FIG. 5, first, the CPU 21 downloads the file for installing 210 that corresponds to the selected application from the server apparatus 2 in S1.

Next, it is determined whether or not the signature data 212 is included in the file for installing 210 in S2. If it is included, the signature data 212 is verified as described above in S3 (including determining the signature type).

Next, the step proceeds to S4. If the CPU 21 determines that the signature included in the downloaded file for installing 210 is correct (no problem) based on the verification result, the step proceeds to S5.

In S5, the CPU 21 determines whether or not the type of signature included in the downloaded file for installing 210 is installable with reference to information shown in TABLE 1.

If it is determined that the signature type is installable, it is determined that the application corresponding to the downloaded file for installing 210 is installable in S6, and the step proceeds to S7.

In case of determining NO in S2, S4, or S5, the CPU 21 determines that the application corresponding to the downloaded file for installing 210 is not installable in S10. Subsequently, the step proceeds to S11, and the installation process is aborted.

Next, the step proceeds to S11. The CPU 21 discards the downloaded file for installing 210, and the process shown in FIG. 5 ends. It is preferable that it is not authorized to install is reported.

By contrast, if the step proceeds to S7, the CPU 21 performs installing the application corresponding to the downloaded file for installing 210. Subsequently, in S8, with reference to the signature information (TABLE 1), the CPU 21 specifies the function that the installed application utilizes among functions that the main unit 10 includes in accordance with the type of signature included in the file for installing 210.

Next, in S9, the specified type of the function (function range) is registered in the application information table (TABLE 2) additionally in association with the identification information of the application, and the process shown in FIG. 5 ends.

In the above description, the registration is processed in S3, S8, and S9, and the CPU 21 functions as a registration unit in these steps.

Afterwards, the CPU 21 can get hold of the functions that the main unit 10 includes utilized by the installed application with reference to the application information table. In addition, since the function included in the application to be registered itself is not used in registering and acquiring the information necessary for the registration in S9, it is possible to get hold of the functions that the main unit 10 includes utilized by the installed application for whichever application if the correct signature is added to the application.

The control unit 20 stores authority information that registers the type of functions that the main unit 10 includes and can be authorized a user to use for each user. The user who wants to use the control unit 20 is authenticated using password etc., and each user is authorized to use only functions registered in the authority information. It is possible that the main unit 10 can store the authority information.

For example, the authority information can be registered in the authority information table shown in TABLE 3 associated with the user name and utilization authority that indicates functions authorized to use.

TABLE 3
Authority information table

| User name | Utilization authority | Utilizable applications |
|---|---|---|
| Suzuki | Copier, Scanner, | ScanToCloud, EcoCopy, |
| | Printer, and Fax | Confidential Printing |
| | | application, EasyFaxSending |
| | | application, and ScanToMe |
| | | application |
| Tanaka | Scanner | ScanToCloud application and |
| | | ScanToMe application |
| Saito | None | None |
| Takahashi | Copier | EcoCopy |
| Satoh | Copier and Printer | EcoCopy and Confidential |
| | | Printing application |

In addition, in the authority information table, information that indicates applications that users are authorized to use is registered too. With reference to the application information table (TABLE 2), it is possible to register the name of the application that uses functions that each user is authorized to utilize as “Applications authorized to use”.

In TABLE 3, for example, since user Suzuki can utilize functions Copier, Scanner, Printer, and Fax, Suzuki can use all applications registered in TABLE 2. Since user Tanaka can use the scan function only, Tanaka can utilize ScanToCloud application and ScanToMe application that utilize the scan function only and do not utilize other functions. Since user Satoh can utilize the copy function and print function, Satoh can utilize only EcoCopy and Confidential Printing application.

Some users do not have utilization authority to utilize the functions that the main unit 10 includes just like Saito. In that case, those users still can utilize applications that do not utilize the functions included in the main unit 10. Examples of such applications are Operating Manual, Signage, Calendar application, News Viewer application, Weather Report application, ToDo Task management application, and Image Viewer.

The registration of the applications authorized to use can be updated when a new application is installed or user's utilization authority is modified. Otherwise, when a user logs in, information regarding the logged user can be generated with reference to the utilization authority and the application information table at that point.

It should be noted that applications can be installed regardless of the utilization authority shown in TABLE 3. (However, it is possible to set up authority information that specifies whether or not applications can be installed.) Consequently, in some cases, it is possible that a user cannot utilize an application while the application is installable.

Nevertheless, on the control unit 20, it is controlled in the way that each user can only utilize applications that the user is authorized to use and cannot utilize applications that the user is not authorized to use. In particular, it is possible to display icons to launch the application that the user is authorized to use on the operational screen and not display icons to launch the application that the user is not authorized to use.

Next, in association with this point described above, the process performed by the CPU 21 in the control unit 20 shown in FIG. 2 in case of requesting to log in with reference to FIG. 6.

FIG. 6 is a flowchart illustrating the control unit shown in FIG. 2 requesting login.

If the CPU 21 in the control unit 20 accepts input of request for logging in, user ID, and password by user operation, the CPU 21 in the control unit 20 starts the process shown in FIG. 6. First, the CPU 21 in the control unit 20 performs user authentication based on the input user ID and password in S21.

That is, after the CPU 21 determines whether or not the combination of the input user ID and password corresponds to those of any registered user, it is determined that the user authentication succeeded if they correspond and that the user authentication failed if they do not correspond. Otherwise, it is still possible to perform the authentication process by using the login name etc.

Next, the step proceeds to S22. The CPU 21 determines whether or not the user authentication succeeded. If the user authentication failed, the process shown in FIG. 6 ends immediately. If the user authentication succeeded, the step proceeds to S23, and the user logs in the main unit 10.

Next, the step proceeds to S24. With reference to the authority information table (TABLE 3), the CPU 21 displays an icon to launch the operational screen corresponding to the function that the logged in user has authority to utilize among functions included in the main unit 10 on the screen of the control panel 27.

Next, with reference to the application information table (TABLE 2) and the authority information table (TABLE 3), the CPU 21 specifies the application that the user is authorized to utilize among applications installed in the control unit 20 as described above in S25.

In S26, the CPU 21 determines whether or not there is an application that the user is authorized to utilize. If not, the process ends. If so, the step proceeds to S27. Subsequently, the CPU 21 displays an icon to launch the application that the logged in user is authorized to utilize among applications included in the control unit 20 on the home screen displayed on the control unit 20, and the process ends. Regarding applications that the user is not authorized to utilize, icons of those applications are not displayed on the screen. Consequently, it is controlled that the user cannot utilize those applications.

FIG. 7 is a diagram illustrating a home screen displayed by the process shown in FIG. 6 if user Satoh shown in TABLE 3 logs in.

On the home screen 500 shown in FIG. 7, icons 501, 502, 503, and 504 are displayed. Among these icons, the icon 501 is the icon to launch the operational screen corresponding to the copy function included in the main unit 10. The icon 502 is the icon to launch the operation screen corresponding to the print function included in the main unit 10. The icon 503 is the icon to launch the EcoCopy application installed in the control unit 20. The icon 504 is the icon to launch the Confidential Printing application installed in the control unit 20. Only icons to launch applications that utilizes functions and function range that user Satoh has authority to utilize are displayed on the home screen 500.

Consequently, by performing the process shown in FIG. 6, it is possible that icons related to functions that the user does not have authority to utilize and icons to launch applications that utilize functions that the user is not authorized to use (applications not authorized to use) are not displayed on the screen and these functions and applications are prohibited to utilize.

In the steps S25 and S27 shown in FIG. 6, the CPU 21 functions as a prohibition unit.

Otherwise, it is still possible to prohibit utilizing applications similarly by displaying icons to launch applications that the user is not authorized to use on the home screen, determining that an error occurs in launching the application, and displaying a message reporting that the application is not launched due to some error on the home screen.

The number of functions that an application utilizes is not limited to one. As shown in TABLE 4, some applications can utilize multiple functions. In this case, the types of functions that the application utilizes are registered in the signature information table (TABLE 1) in association with the type of signature added to the application.

For example, since ScanToCloud and Printing application utilizes both the scan function and the print function, only users who have authority to utilize both the scan function and the print function can use the application.

In TABLE 5, it is indicated whether or not the users who have the same authority as shown in TABLE 3 can use those applications.

TABLE 4
Application information table

| Application name | Functional category |
|---|---|
| ScanToCloud and Printing | Scanner and Printer |
| application | |
| Scan and FAX Multicast | Scanner and Fax |
| application | |

TABLE 5
Authority information table

| User name | Utilization authority | Utilizable application |
|---|---|---|
| Suzuki | Copier, Scanner, | ScanToCloud Printing |
| | Printer, and Fax | application and Scan and |
| | | FAX Multicast application |
| Tanaka | Scanner | None |
| Saito | None | None |
| Takahashi | Copier | ScanToCloud Printing |
| | | application |
| Satoh | Copier and Printer | Scan and FAX Multicast |
| | | application |

On the control unit 20, it is possible to update the installed application due to version up etc. Next, the process performed by the CPU 21 in the control unit 20 in case of updating the application with reference to FIG. 8.

FIG. 8 is a flowchart illustrating the control unit shown in FIG. 2 updating the application.

If the CPU 21 in the control unit 20 accepts input of selecting an application to be updated or a command to update the application, the CPU 21 in the control unit 20 starts the process shown in FIG. 8. The selection of the application and the request to update the application can be performed by user operation on the control panel 27, or they can be performed automatically in case of satisfying predetermined condition configured preliminarily (e.g., reaching at configured time).

In the process shown in FIG. 8, first, the CPU 21 downloads the file for installing 210 that corresponds to the selected application from the server apparatus 2 in S31.

Next, in S32, the CPU 21 acquires program version from attribution of the downloaded file for installing 210, compares it with version of installed application, and determines whether or not both versions are the same.

If it is determined that both versions are the same, the CPU 21 determines whether or not the signature data 212 is included in the downloaded file for installing 210 in S34. If so, the signature is verified in S35, and it is determined whether or not the type of included signature is the same as the type of signature added to the installed application in S36.

If not (NO in S36), it is determined that the signature is updated while the version of the application is not updated. Therefore, the application is installed (or the installation is stopped) and functions that the application utilizes are registered in accordance with the type of signature added to the application in the steps from S38 to S45 just like the steps from S5 to S12 in FIG. 5.

If there is no signature data 212 in S34, since it is not authorized to install the application, the installation is stopped (in the steps from S43 to S45). If the signatures are the same in S36, since it is unnecessary to install the application newly, the installation is stopped too (in the steps from S43 to S45).

If the versions are not the same in S33, the CPU 21 verifies the signature data 212 in S37. Subsequently, the CPU 21 installs the application (or stops installing the application) and registers functions that the application utilizes in accordance with the type of signature added to the application (in the steps from S38 to S45). In this case, since it is determined that the application is updated, the installation is performed even if the type of signature is the same as signature added to the installed application. However, the installation is not performed if the correct signature is not added to the application or signature whose type is not installable is added to the application.

If the versions are not the same in S33, it is possible to stop the installation or ask the user whether or not to stop the installation in case the version of the downloaded file for installing 210 is older than the version of the installed application.

As described above, it is possible to update the application and update the content of the application information table in accordance with the type of signature added to the updated application. Even if the versions are the same, it is still possible to update the content of the application information table in case the type of signature added to the application is not the same.

In the process shown in FIG. 8 described above, the CPU 21 functions as an update unit.

In the first embodiment described above, the control unit 20 registers the type of functions that the application utilizes among the functions that the main unit 10 includes in accordance with the signature added to the application (signature corresponding to application installed in the control unit 20) in installing the application. Therefore, it is possible to specify the function that the application utilizes instead of depending on the function included in the application.

Consequently, with reference to the user's utilization authority, it is possible to prevent each user from utilizing application that utilizes functions that the user has no authority to utilize them instead of depending on the function included in the application.

In the embodiment described above, this limitation on utilization is realized by referring to the authority information that functions included in the main unit 10 that the user is authorized to utilize are registered for each user and preventing the user who utilizes the control unit 20 from utilizing the application that utilizes the functions that the user is not authorized to use.

As a result, it is possible to prevent the user who utilizes the control unit 20 from utilizing the functions that the user is not authorized to use through using the application. In addition, this limitation on utilization can be realized instead of the function included in the application to be restricted.

Consequently, in case of not being able to access a function that relates to limiting application function utilization, such as even if the manufacturer of the image processing system 1 is different from the manufacturer of the application and the manufacturer of the image processing system 1 cannot grasp the application program in detail, it is possible to limit the utilization appropriately.

In addition, by reinstalling the application, the control unit 20 can update the signature corresponding to the application. That is, even if the version of the program is the same, by reinstalling the application with different signature, it is possible to update the signature added to the application (and register utilized function corresponding to the signature). Consequently, in registering the application in the server apparatus 2, if the wrong signature that does not correspond to the functions of the applications is added to the application, it is possible to fix the problem.

Only in the case of configuring predetermined special mode, the control unit 20 can display the list of installed applications including the applications that the user is not authorized to utilize, and it is possible to select applications to be updated from the list. Subsequently, in updating the application, it is possible to update the signature added to the application. For example, in case of configuring the installed commercial application as not launchable by adding the signature of Pattern B in TABLE 1, it is possible to make the application launchable by installing the updated application with different signature in the server apparatus 2.

### Second Embodiment

Next, the image processing system in the second embodiment is described below. In this second embodiment, while a part of particular operation of each apparatus is different from the first embodiment, the hardware configuration and the software configuration are similar to the first embodiment, so the second embodiment is described below with reference to FIGS. 1, 2, and 3 appropriately. That is also applied to the third embodiment and later.

In the second embodiment, instead of the server apparatus 2 in the first embodiment, a download server 2a that distributes the file for installing application and an authentication server 2b as an authorization apparatus that approves the utilization of the application (gives approval) are set up. It should be noted that the download server 2a and the authentication server 2b can be integrated.

First, a basic operation that the control unit 20 downloads and installs the application in the second embodiment is described below with reference to FIG. 9.

FIG. 9 is a diagram illustrating an operation that the control unit 20 downloads and installs the application in the second embodiment, and same symbols are assigned to items common with FIG. 4.

In the second embodiment, as shown in FIG. 9, the control unit 20 can communicate with the download server 2a and the authentication server 2b (activation server) via the network 3.

In case of accepting selecting application to be downloaded and command to download the application by user operation, the control unit 20 requests the download server 2a to download the file for installing the selected application 210 and downloads the file for installing the selected application 210 from the download server 2a (1). Next, the control unit 20 checks the signature data 212 included in the downloaded file for installing 210 and determine whether or not it is OK to install the downloaded application (2). This determination is performed by the same steps as in the first embodiment (from S2 to S5 in FIG. 5).

If it is determined that it is OK to install the application, the application is installed without accessing the authentication server 2b by the same step as in the first embodiment (S7 in FIG. 10).

By contrast, if there is no signature or the signature is not correct (e.g., expired), the control unit 20 accesses the authentication server 2b and performs the activation (3).

In performing the activation, the control unit 20 accepts inputting an activation code for the application by user operation. The activation code indicates that the user has authority to utilize the application, and the application vendor can provide the activation code in return for user registration or payment for cost of the application.

Next, the control unit 20 transfers the input activation code to the authentication server 2b along with identification information of the application (the application file itself can be transferred instead) and requests to authorize the utilization of the application (activation).

The authentication server 2b manages an authorized application list table 221 (authority information) that indicates applications that is authorized to utilize for each of the activation codes. After accepting the request for authorization to utilize the application, the authentication server 2b performs the following determination. That is, based on the received information and the authorized application list table 221, the authentication server 2b determines whether or not it is OK to authorize utilization of the requested application. Subsequently, the authentication server 2b returns the authentication result to the control unit 20.

If the authentication server 2b authorizes to use the application, the authentication server 2b transfers information on the function included in the main unit 10 and utilized by the application, i.e., information to be registered in the function category field in the application information table (Table 2) to the control unit 20 along with the authorization result.

In case of authorizing to use the application by the authentication server 2b, the control unit 20 installs the application just like the case in the first embodiment (4) and registers the type of function utilized by the application in the application information table. In this case, the activation code used for the activation is stored.

By contrast, in case of not authorizing to use the application, the installation is stopped.

As described above, in the case of performing the activation by the authentication server 2b instead of checking by the signature, similarly to the case in the first embodiment, it is possible to determine whether or not it is OK to perform the installation and restrict the utilization of functions.

In the description above, while the activation is performed if there is no appropriate signature in FIG. 9, the activation can be performed even if there is the appropriate signature.

Next, an operation that the CPU 21 in the control unit 20 shown in FIG. 2 installs the application is described below.

FIG. 10 is a flowchart illustrating the control unit 20 shown in FIG. 2 installing the application. The same reference numbers are assigned to steps common with FIG. 5.

After receiving the selection of the application to be downloaded and the request to download the application, the CPU 21 in the control unit 20 starts the process shown in FIG. 10.

If the determination in S2 and S4 is NO, the CPU 21 performs following operation in S52 and S53.

The particular operation is described below with reference to FIG. 11.

FIG. 11 is a sequence diagram illustrating a process that the control unit 20 requests the server apparatus to authorize to use the application, receives the authorization result, and installs the application.

After receiving inputting the activation code of the application by user operation, the CPU 21 in the control unit 20 transfers the input activation code to the authentication server 2b along with the identification information of the application and requests to authorize to use the application in S101 (corresponding to S52 in FIG. 10).

After receiving this information from the control unit 20 and being requested to authorize to use, the authentication server 2b determines whether or not it is OK to authorize the user who owns the activation code to use the requested application as described above in S102. Subsequently, the authentication server 2b transfers the authorization result (activation result) to the control unit 20 in S103. In addition, if it is authorized to use the application, the information that indicates functions included in the main unit 10 and utilized by the target application is transferred concurrently.

After receiving the authorization result, the control unit 20 determines whether or not it is OK to install the application based on the authorization result in S104 (corresponding to S53 in FIG. 10). If the utilization is authorized, it is OK to install (activation succeeded). Otherwise, it is not OK to install.

If it is OK to install, the control unit 20 performs the installation of the application in S105 (corresponding to S7 in FIG. 10).

Next, the control unit 20 specifies the types of the functions utilized by the application among a plurality of functions included in the main unit 10 based on the authorization result (and the accompanying information) and registers the specified information in the application information table (Table 2) in S106 (corresponding to S51 and S59 in FIG. 10). Subsequently, the process in FIG. 10 ends.

By contrast, if the received authorization result indicates that the utilization is not authorized (activation failed) (not shown in FIG. 11 but NO in S53 in FIG. 10), the control unit 20 determines that it is not OK to install the application corresponding to the downloaded file for installing 210, the step proceeds to S11, and the installation process is stopped.

Next, the step proceeds to S12, the CPU 21 discards the downloaded file for installing 210, and the process shown in FIG. 10 ends.

As described above, in the second embodiment, when the control unit 20 installs an application in itself, the control unit 20 requests the authentication server 2b (the predetermined authorization unit) to authorize utilization of the application. Subsequently, if the authentication server 2b authorizes the utilization, the types of the functions that is authorized the application to utilize is configured based on the authentication result. Consequently, it is possible to install the applications that have no signature.

In addition, if the application is already installed, it is possible to perform activating the application only. In this case, just like the case in S102 and S103 in FIG. 11, the authentication server 2b determines whether or not it is OK to authorize to use the application and transfers the authentication result too.

If the information on the functions utilized by the application reported at this point is different from the registered content of the functional category in the application information table, it is possible to update the registered content of the functional category in the application information table. By doing this, the same result as in the case that the signature added to the application is updated in the first embodiment can be achieved.

Consequently, in case of configuring an application distributed in the state of unlaunchable and installed in the beginning as launchable after confirming charging for the application, it is unnecessary to download the application again, and that can improve the processing efficiency.

### Third Embodiment

Next, the image processing system in the third embodiment is described below. Since this third embodiment is just slightly different from the second embodiment described above, only those different points are described below.

In the third embodiment, the CPU 21 in the control unit 20 performs an operation described below in S52 and S53 in FIG. 10. The specific operation is described below with reference to FIG. 12 too.

FIG. 12 is a sequence diagram illustrating a process that the control unit 20 requests the authentication server 2b to sign the application, receives the signature result, and installs the application.

In requesting the authentication server 2b to authorize to use the application, the CPU 21 in the control unit 20 transfers the apk file 211 included in the downloaded file for installing 210 and the input activation code to the authentication server 2b and requests to sign the apk file 211 in S201.

After receiving this information from the control unit 20 and accepting the request to sign, the authentication server 2b determines whether or not it is OK to authorize the owner of the activation code to utilize the requested application in S202 just like the case in S102 in FIG. 11.

Next, the authentication server 2b adds the authentication result and the signature corresponding to the type of application to the received apk file 211 in S203 and replies to the control unit in S204.

If it is not authorized, the signature that indicates that the application is unlaunchable just like Pattern A and B in TABLE 1 is added (still the application can be installed). By contrast, if it is authorized, the signature that indicates that application is installable and indicates the type of functions utilized by the application and included in the main unit 10 just like Pattern from C to H in TABLE 1 is added. The apk file 211 that includes the signature can be the same format as the file for installing 210.

In this embodiment, the authentication server 2b described above functions as the authentication unit.

After receiving the apk file 211 that includes the signature, the control unit 20 verifies the signature and determines whether or not it is OK to install the application based on the signature type with reference to the signature information table in S205.

Next, if it is OK to install, the control unit 20 performs installing the application in S206.

Next, based on the type of signature added to the apk file 211, the control unit 20 specifies the function utilized by the installed application among the functions included in the main unit 10 and registers the information in the application information table (Table 2) in S207.

As described above, in the third embodiment, the control unit 20 requests the authentication server 2b (the predetermined authentication unit) to sign the program to realize the function of the application. After receiving the program that includes the signature in accordance with the request from the authentication server 2b, the signature added to the program is used as the signature corresponding to the application. Consequently, the same effect as in the second embodiment can be achieved.

In the case of custom applications etc., it is difficult to add the signature to the application preliminarily in some cases. However, even in this kind of case, with the process shown in FIG. 12, just by registering the identification information of the apk file 211 and the information on its utilization functions, the control unit 20 can acquire the application data that includes the signature after the fact. As a result, it is possible to determine whether or not it is OK to install and register the utilized functions in the same way as in the case of downloading the application that includes the signature from the start.

In case of attaching a storage medium such as a SD card to the control unit 20 and installing an application that has no signature on the Android market etc. specially authorized by the administrator via the storage medium, it is possible to provide the utilization permission in the same way as described above. This case is similar in the fourth embodiment described later too.

### Fourth Embodiment

Next, the image processing system in the fourth embodiment is described below. Since this fourth embodiment is just slightly different from the third embodiment described above, only those different points are described below.

The specific operation is described below with reference to FIG. 13 too.

FIG. 13 is a sequence diagram illustrating a process that the control unit 20 requests the server apparatus to sign the application, receives the signature result, and installs the application. In FIG. 13, the same symbols are assigned to the part corresponding to FIG. 12.

The difference between the process shown in FIG. 13 and the process shown in FIG. 12 is that the control unit 20 transfers the apk file 211 and the activation code to not the authentication server 2b but the download server 2a and the operation of the download server 2a that received the apk file 211 and the activation code transferred from the control unit 20 only. In addition, in the process shown in FIG. 13, it is basically assumed that, after installing an application without signature or an unusable application on the control unit 20, it is requested to sign the application to the download server 2a.

After receiving that information and the request for signing the application, just like the case in S102 in FIG. 11, the download server 2a determines whether or not it is OK to authorize the owner of the activation to utilize the requested application in S301.

If it is OK (YES in S302), the download server 2a searches for the file for installing 210 of an application whose name is the same as the received apk file 211 in S303. If the download server 2a finds the file for installing 210, the download server 2a transfers it to the control unit 20 in S204.

The file for installing 210 includes the signature data 212 as described above with reference to FIG. 4.

By contrast, if the download server 2a cannot authorize utilization of the application or find the file for installing, the download server 2a returns the received apk file 211 as the file for installing to the control unit 20 without adding the signature to the received apk file 211.

Consequently, just as in the case shown in FIG. 12, in response to the request for signing, the control unit 20 can receive the file for installing 210 with the signature in accordance with success or failure of the activation and the functions utilized by the application (or without signature).

As a result, it is possible to achieve the same effect as in the third embodiment. Furthermore, since it is unnecessary for the download server 2a to add the signature to the apk file newly, it is unnecessary to manage the information on which signature is added to which application. In addition, if the file for installing 210 that the download server 2a transfers to the control unit 20 is the latest, the application can be updated when the signature is added practically.

These features are useful if a developing version of an application is installed in the control unit 20 first and it is replaced with a release version of the application subsequently.

The embodiment described above can be implemented by having a computer execute a program that implements functions described above by the CPU 21 that controls the control unit 20.

The program can be stored in a HDD, a ROM, or other nonvolatile storage media (flash memory or EEPROM etc.) included in the computer preliminarily. Also, it can be provided storing nonvolatile storage media such as CD-ROM, memory card, flexible disk, MO, CD-R, CD-RW, DVD+R, DVD+RW, DVD-R, DVD-RW, or DVD-RAM etc. Steps described above can be executed by installing the program stored in the storage media on the computer and executing it. Furthermore, it is possible to download the program from an external apparatus that includes the storage media that stores the program or stores the program in a storage unit, install the program in the computer, and execute it.

In addition, it is possible to download the program from an external apparatus that includes the storage device that stores the program or an external apparatus that stores the program in the storage unit, install the program in the computer, and execute the program by the computer.

In the present invention, the specific configuration of each unit, content of process, and sequence of communication is not limited to the embodiment described above.

For example, the control unit 20 can register the type of functions utilized by the application (functional range) in accordance with the vendor name of the application (vendor code) corresponding to the electronic signature type, e.g., as shown in TABLE 6.

In addition, functions listed in Table from 1 to 5 can be defined more detailedly.

TABLE 6
Signature information table

| | | Function range |
|---|---|---|
| Signature type | Vendor name | (main unit function) |
| Pattern A | Corporation A | Application is not usable. |
| Pattern B | Corporation B | Only application that does |
| | | not utilize functions included |
| | | in the main unit is usable. |
| Pattern C | Corporation C | Application function (Copier) |
| Pattern D | Corporation D | Application function |
| | | (Scanner) |
| Pattern E | Corporation E | Application function (Printer) |
| Pattern F | Corporation F | Application function (Fax) |
| Pattern G | Corporation G | Application function (Copier |
| | | and Scanner) |
| Pattern H | Corporation H | All application functions and |
| | | configuration |
| No signature | None | Application is not |
| | | launchable. |

For example, while the image processing system 1 is comprised of the main unit 10 and the control unit 20 fixedly in the embodiment described above, the image processing system 1 is not limited to that example.

The control unit and the main unit (operating unit) can be completely separated hardware components. For example, the image processing system or the information processing system can be comprised of a mobile device such as a smart phone as the control unit and the image processing apparatus such as the MFP as the operating unit. Especially, in case the control unit is connected with the operating unit using wireless communication, these units can be configured as completely independent apparatuses.

In addition, it is unnecessary that the control unit corresponds to the operating unit on a one-on-one basis. For example, it is possible that the mobile device can operate the image processing apparatus that includes the control unit connected to the main unit by wired communication. Otherwise, multiple mobile devices can operate one image processing apparatus. Furthermore, one mobile device can operate multiple image processing apparatuses changing the operation target.

In addition, it is unnecessary to implement all functions of the control unit 20 and the main unit 10 in one apparatus. Multiple apparatuses can implement the functions of the control unit 20 and the main unit 10 by cooperating with each other. By contrast, it is possible to contain the control unit 20 and the main unit 10 in one case. Otherwise, when the control unit executes the application, it is possible to utilize multiple operating units simultaneously or selectively.

It is unnecessary that the operating unit includes the image processing engine such as the scanner or plotter. Any information processing apparatus can be used for that purpose so long as it operates based on a command received by the control unit. In addition, an apparatus that performs outputting physically other than processing information can also be used.

The present invention also encompasses an image processing method performed by an image processing system that includes an control unit to accept input and an operating unit to execute information processing based on the input accepted by the control unit. The method includes the step of registering functional information that indicates the type of function utilized by an application among a plurality of functions included in the operating unit in accordance with an electronic signature linked to the application included in the control unit.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

What is claimed is:

1. An information processing system, comprising:
a control unit to accept input;
an operating unit to execute information processing based on the input accepted by the control unit; and
a registration unit to register functional information that indicates the type of function utilized by an application among a plurality of functions included in the operating unit in accordance with an electronic signature linked to the application included in the control unit.

2. The information processing system according to claim 1, further comprising a prohibition unit to prevent unauthorized utilization of an application based on:
authorization information that registers the type of function authorized; and
the functional information registered by the registration unit.

3. The information processing system according to claim 1, further comprising an update unit to update an electronic signature linked to an application by reinstalling the application in the control unit.

4. The information processing system according to claim 1, further comprising a unit to request a authorization to utilize an application upon installation of the application in the control unit,
wherein the registration unit registers the type of function utilized by the installed application if the authentication apparatus authorizes utilization of the application.

5. The information processing system according to claim 1, further comprising:
a unit to request a an electronic signature for a program that implements functions of an application upon installation of the application in the control unit; and
a unit to receive the program to which the electronic signature in response to the request is added.

6. The information processing system according to claim 1, wherein the registration unit registers the type of function utilized by the application in accordance with a name of a vendor of the application corresponding to the electronic signature.

7. An information processing apparatus comprising,
a control unit to accept input, which causes an operation unit to execute information processing; and
a registration unit to register functional information that indicates the type of function utilized by an application among a plurality of functions included in the operating unit in accordance with an electronic signature linked to the application included in the control unit.

8. A non-transitory recording medium storing a program that, when executed by an information processing system that comprises a control unit that accepts input and an operating unit that executes information processing based on the input accepted by the control unit, causes the information processing system to implement a method of processing information,
the method comprising the steps of:
accepting input;
executing information processing based on the input accepted by the control unit; and
registering functional information that indicates the type of function utilized by an application among a plurality of functions included in the operating unit in accordance with an electronic signature linked to the application included in the control unit.
